(19) United States
(12) Patent Application Publication
(10) Pub. No.: US 2010/0060414 A1
(43) Pub. Date: Mar. 11, 2010

(54) ELECTRIC DOOR LOCK DEVICE

(76) Inventor: Doo Man Im, Gwangju (KR)

Correspondence Address: BERLINER & ASSOCIATES, 555 WEST FIFTH STREET, 31ST FLOOR, LOS ANGELES, CA, 90013, US

(21) Appl. No.: 12/307,714

(22) PCT Filed: Jul. 6, 2007
(86) PCT No.: PCT/KR2007/003303

§ 371 Date: Aug. 27, 2009

(30) Foreign Application Priority Data
Jul. 7, 2006 (KR) 10-2006-0063898
Apr. 27, 2007 (KR) 10-2007-0041628

(51) Int. Cl. G06F 7/04; E05B 65/00

(52) U.S. Cl. 340/5.54; 70/91; 340/5.6

(57) ABSTRACT

An electric door lock device is provided, including a user identification (ID) device provided on a manipulation body installed on the outside of a door and configured to input user's unique ID information; an operation body connected to the manipulation body and including a locking rod driver driving a locking rod for opening/closing the door to be in an unlocked/locked state; and a controller controlling the locking rod driver to drive the locking rod to a retracted position when user's unique ID information input through the user identification device is identical with user information registered in a memory device, transmitting access information of the user to an administrator's wireless communication terminal registered through a communication device, and storing the access information in the memory device. According to the electric door lock device, access information of a person who entered/exited can be notified to the administrator's wireless communication terminal.

### TECHNICAL FIELD

The present invention relates to an electric door lock device, and more particularly, to an electric door lock device configured to record access information of a person who entered/exited a door and to notify a remotely located administrator of the access information of the person who entered/exited the door.

### BACKGROUND ART

An electric door lock device includes a manipulation body installed on the outside of a door and provided with key buttons including numeric keys, and an operation body connected to the manipulation body to allow a locking rod to be locked or unlocked according to manipulation of key buttons.

The electric door lock device is configured to be unlocked the locking rod if a number input by user's manipulating key buttons is identical with a security number registered therein, thereby allowing the user to enter/exit the door.

However, according to the conventional electric door lock device, especially when installed on a door of an office or company building with accesses of multiple employees, it is quite difficult to identify access information about persons who entered/exited, access time, and so on. Therefore, even if one of the multiple employees comes back to deceitfully take away important information or properties of the office or company building after the business hours, it is not possible to track down the one who committed theft.

Further, according to the conventional electric door lock device, it is not possible to check from a remote location whether one of family members is home or not.

### DISCLOSURE OF INVENTION

### Technical Problem

To solve the above problems, it is an object of the present invention to provide an electric door lock device configured to record access information of a person who entered/exited and to rapidly notify a remotely located administrator of the access information of a person who entered/exited.

### Technical Solution

According to an aspect of the present invention, there is provided an electric door lock device including: a user identification (ID) device provided on a manipulation body installed on the outside of a door and configured to input user's unique ID information; an operation body connected to the manipulation body and including a locking rod driver driving a locking rod for opening/closing the door to be in an unlocked/locked state; and a controller controlling the locking rod driver to drive the locking rod to a retracted position when user's unique ID information input through the user identification device is identical with user information registered in a memory device, transmitting access information of the user to an administrator's wireless communication terminal registered through a communication device, and storing the access information in the memory device.

According to another aspect of the present invention, there is provided a provided an electric door lock device including: a user identification (ID) device provided on a manipulation body installed on the outside of a door and configured to identify registered information by user; a key manipulation part having a plurality of key buttons provided on the manipulation body to input a password; a display part provided on the manipulation body and displaying display information; an operation body connected to the manipulation body and provided with a locking rod driver driving a locking rod for opening/closing the door to be in an unlocked/locked state; and a controller controlling the locking rod driver to drive the locking rod to a retracted position when user's unique ID information identified by the user identification device and the password input through the key manipulation part are identical with the registered information by user and a first security number registered in a memory device, transmitting access information of the user to an administrator's wireless communication terminal registered through a communication device, and storing the access information in the memory device.

### BRIEF DESCRIPTION OF THE DRAWINGS

FIG. 1 is a perspective view of an electric door lock device according to an embodiment of the present invention;

FIG. 2 is a block diagram of a controlling circuit of the electric door lock device shown in FIG. 1:

FIG. 3 is a flowchart illustrating an exemplary controlling procedure of a controller for information input through a key operation unit shown in FIG. 1;

FIG. 4 is a perspective view of an electric door lock device according to another embodiment of the present invention;

FIG. 5 is a block diagram of a controlling circuit of the electric door lock device shown in FIG. 4: and

FIG. 6 is a flowchart illustrating an exemplary controlling procedure of a controller for a card user read by a card reader shown in FIG. 4.

### BEST MODE FOR CARRYING OUT THE INVENTION

Hereinafter, embodiments of the present invention will be described in detail with reference to the attached drawings.

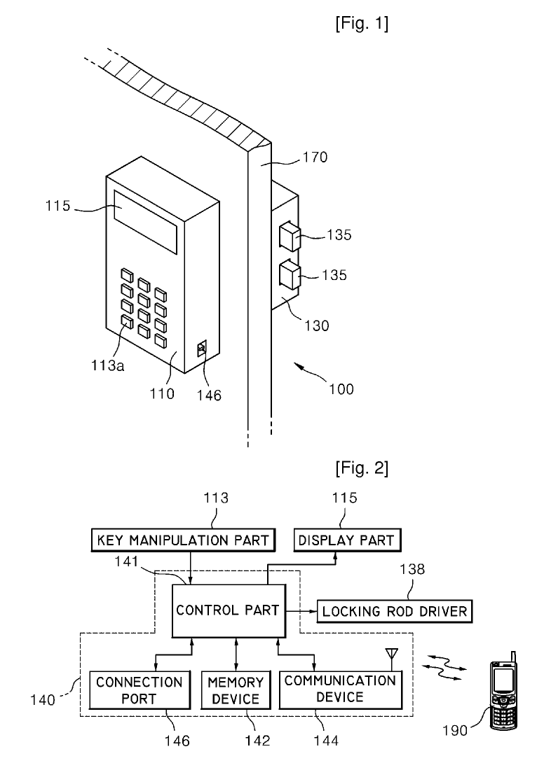

FIG. 1 is a perspective view of an electric door lock device according to an embodiment of the present invention, and FIG. 2 is a block diagram of a controlling circuit of the electric door lock device shown in FIG. 1.

Referring to FIGS. 1 and 2, the electric door lock device 100 includes a manipulation body 110 and an operation body 130.

The manipulation body 110 is mounted on the outside of a door 170 to be exposed outward.

A key manipulation part 113 having a plurality of key buttons 113a is provided on the manipulation body 110 so as to input a variety of information, including numbers and characters.

Preferably, the key buttons 113a include numeric keys, character keys, special character keys, and so on.

A key button configuration for a mobile phone may be taken as an exemplary configuration of the key buttons 113a.

In addition, the key manipulation part 113 is configured to set registration of unique ID information by user to be allowed for access, inputting guide messages to be described later, registration of administrator's telephone number, and so on, by supporting the control part 141 using the key buttons 113a via the display part 115.

Here, the key manipulation part 113 is preferably used as the user identification device by way of example.

The display part 115, provided on the manipulation body 110, is controlled by the control part 141 to be described below, and displays display information.

Unlike in the illustrated embodiment in which the key manipulation part 113 is used as the user identification device, any one selected from a card reader, a fingerprint identification device, an iris identification device, and a voice identification device, may be used as the user identification device. In this case, the card reader, the fingerprint identification device, the iris identification device, or the voice identification device, may be configured to register user's unique ID information to allow the user to be accessed.

Here, when the card reader is used as the user identification device, a card having unique ID information by user recorded thereon is provided to each user. In addition, when the iris identification device, the fingerprint identification device, or the voice identification device is used as the user identification device, each device may be configured to detect a user's fingerprint, iris, or voice.

Generally, the operation body 130 is electrically connected to the manipulation body 110 through a traverse hole of the door 170 and is installed on the inside of the door 170.

In addition, the operation body 130 includes a locking rod driver 138 driving the locking rod 135 to a retracted position when an unlocking signal is received from the control part 141. When a locking signal is received from the control part 141, the locking rod 135 is drawn toward the outside of the operation body 130.

The locking rod 135 of the operation body 130 can be driven by various known mechanisms, including, for example, a pinion driving mechanism in which a rack gear is produced on the locking rod 135 and driven to be locked or unlocked by a motor (not shown). In this case, the locking rod driver 138 includes the motor.

In the aforementioned electric door lock device 100, the manipulation body 110 and the operation body 130 may be configured such that they are physically and electrically connected to each other through the door 170 by means of various known engagement mechanisms.

Among various components of the electric door lock device 100, a battery (not shown) for driving power-based components is embedded in the operation body 130.

The controller 140 is embedded within the manipulation body 110 or the operation body 130.

The controller 140 includes a memory device 142, a communication device 144, and a control part 141.

To allow a user having unique ID information to enter/exit the door, the memory device 142 stores user's unique ID information and user information corresponding to the unique ID information, e.g., information including user names. In addition, the memory device 142 may store a phone number of an administrator's mobile phone, e.g., the wireless communication terminal 190.

In addition, the memory device 142 may have various kinds of information recorded therein, including guide information input by the user, such as user's own birthday or birthdays of user's family members, salutation to be delivered to the person who entered/exited, or other information, through the key manipulation part 113 and the control part 141.

Also, the memory device 142 may have information about access times and names of people who access recorded therein.

The communication device 144 is preferably a wireless communication device capable of performing wireless communications.

The control part 141 controls the locking rod driver 138 to be unlocked if input information input through the key manipulation part 113 is identical with the user's unique ID information stored in the memory device 142. In addition, the control part 141 transmits information about user's access time and information about a person who entered/exited to the administrator's wireless communication terminal 190 registered through the communication device 144, and stores the information in the memory device 142.

In a case where the memory device 142 has a notification time set therein, the control part 141 may be configured to transmit user's access time and information about the person who entered/exited to the administrator's wireless communication terminal 190 registered through the communication device 144 only when user's unique ID information input through the key manipulation part 113 is identical with unique ID information registered in the memory device 142 and an input time of the user's unique ID information corresponds to the set notification time.

Here, the notification time is a predetermined duration of time, which may be optionally set by the administrator and stored in the memory device 142. For example, in a case where the electric door lock device 100 is installed in an office or building, the notification time corresponds to non-business hours. Meanwhile, in a case where the electric door lock device 100 is installed in a home, the notification time corresponds to absence hours during which no body is home.

Accordingly, the notification time may be non-business hours, that is, a duration generally ranging from a quitting time of the day to a starting time of the next day, ranging one hour before the quitting time of the day to one hour after the starting time of the next day, or other appropriate combinations. Here, the notification time may include days off, e.g., Sundays, official holidays, etc.

Accordingly, the administrator can immediately check information about the person who entered/exited at the set notification time through the wireless communication terminal 190.

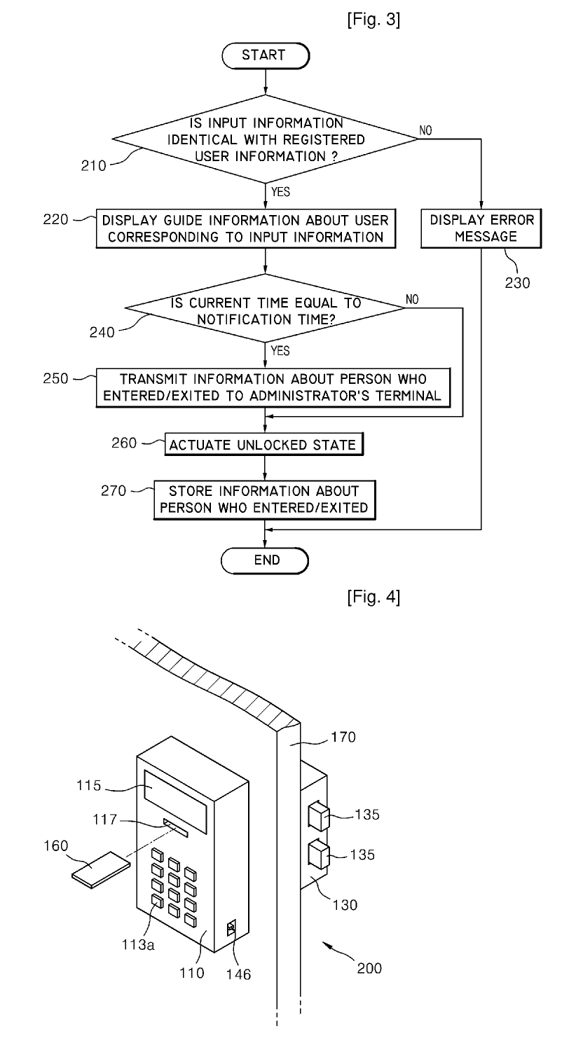

An exemplary controlling procedure performed by a control part 141 will now be described with reference to FIG. 3.

If a user who intends to enter/exit the door inputs user information using the key manipulation part 113, the key manipulation part 113 outputs the input information to the control part 141.

The control part 141 determines whether the input information output from the key manipulation part 113 is identical with user's ID information registered in the memory device 142 in step 210.

If it is determined that the input information from the key manipulation part 113 is identical with user's ID information registered in the memory device 142 in step 210, guide information about a user corresponding to the input information is displayed in step 220. For example, in a case where the current time is a starting time, guide information saying “Good morning! Mr. (Ms.) . . . ” may be displayed. Otherwise, in a case where the user's or his/her family member's anniversary is registered and programmed such that notices are given with regular time intervals 3 days before reaching the corresponding anniversary. For example, if the current date corresponds to the registered date, guide information saying “Mr. (Ms.) Kim! Three more days till your anniversary (e.g., birthday)” may be displayed.

On the other hand, if it is determined in step 210 that the information input by through key manipulation part 113 is not identical with the user information registered in the memory device 142, an error message is displayed on a display part 115 in step 230.

Thereafter, it is determined whether the current time is equal to the set notification time in step 240. If there is any person who entered/exited, the notification time means a time, a day of the week or a date set by the administrator so as to transmit information about information about the person who entered/exited to the administrator's wireless communication terminal 190.

If it is determined that the current time is equal to the set notification time in step 240, information about the user who has attempted to enter/exit the door at the current time, including names of persons who entered/exited and access time, is transmitted to the administrator's wireless communication terminal 190 with a telephone number registered in the memory device 142 in step 250. Here, the information about the person who entered/exited is preferably transmitted in the form of a text message.

On the other hand, if it is not determined that the current time is equal to the set notification time in step 240, the locking rod driver 138 is controlled to be unlocked in step 260.

Next, the information about the person who entered/exited is stored in the memory device 142 in step 270. Here, the information about the person who entered/exited includes access time and name of the person who entered/exited.

Meanwhile, a connection port 146 is installed on the exterior side of the manipulation body 110 so as to take advantage of the information about the person who entered/exited stored in the memory device 142 when necessary.

A USB port may be used as the connection port 146.

Here, transmitting the information about the person who entered/exited stored in the memory device 142 to an external terminal, e.g., a computer, using the connection port 146 is preferably performed only through administrator's authentication under the control of the control part 141.

Meanwhile, the electric door lock device 100 may also be configured such that whenever there is a person who entered/exited, the information about the person who entered/exited is provided to the administrator's wireless communication terminal 190, without separately providing a notification time setting function.

When installed in a home, the electric door lock device 100 allows an administrator, i.e., parent(s), to remotely check an access status of a family member or child through a wireless communication terminal 190.

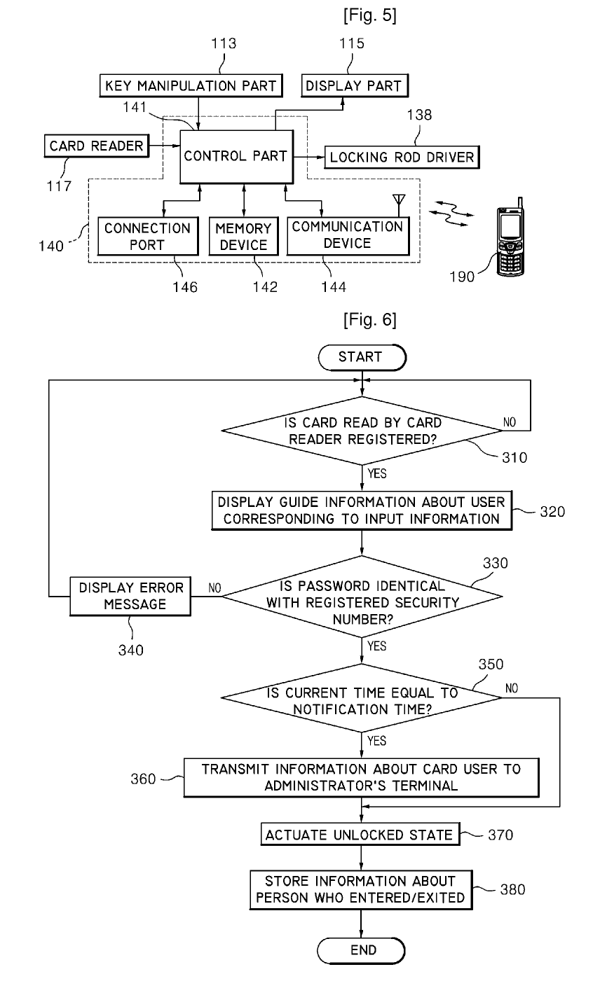

FIG. 4 is a perspective view of an electric door lock device according to another embodiment of the present invention, and FIG. 5 is a block diagram of a controlling circuit of the electric door lock device shown in FIG. 4. The same functional elements as those in the previous drawings are denoted by the same reference numerals.

Referring to FIGS. 4 and 5, the electric door lock device 200 includes a manipulation body 110 and an operation body 130.

A key manipulation part 113 and a card reader 117 are provided on the manipulation body 110.

A key manipulation part 113 has a plurality of key buttons 113a, including numeric keys so as to input a variety of character information, including security numbers.

The card reader 117, which is used as a user identification device by way of example, reads information recorded on a card 160 and outputs the read information to the control part 141.

In the illustrated embodiment, a structure capable of reading a card 160 inserted into a card slot of the card reader 117 is provided by way of example. The card reader 117 may be constructed as any one of a variety of publicly known card readers of either a contact type or a non-contact type. An RF card reader may also be used as an example of a non-contact type card reader.

Unlike in the illustrated embodiment, any one selected from an iris identification device, a fingerprint identification device, a voice identification device, and various known means capable of identifying user's unique information may be used as the user identification device.

The controller 140 includes a memory device 142, a communication device 144 and a control part 141.

To allow a user having unique ID numbers to enter/exit the door, the memory device 142 stores user's unique ID information and user information corresponding to the unique ID numbers, e.g., information including user names. In addition, the memory device 142 may store a phone number of an administrator's mobile phone, e.g., the wireless communication terminal 190.

Further, the memory device 142 may store a first security number for allowing a user authorized by the card reader 117 to be accessed through a password inputting step, and a second security number that can be in a case where the card 160 is lost. Here, the same first security number may be used for the same user. Alternatively, various first security numbers may be used for different users.

When user's unique ID information read by the card reader 117 and the password input through the key manipulation part 113 are identical with information by user registered in the memory device 142 and the first security number, the control part 141 controls the locking rod driver 138 to be unlocked the locking rod 135. In addition, the control part 141 controls access information of a person who entered/exited to be transmitted to the administrator's wireless communication terminal and controls the access information to be stored in the memory device 142.

On the other hand, the control part 141 controls the locking rod driver 138 to drive the locking rod 135 to an unlocked position without additional user identification step performed by the card reader 117 if the password input through the key manipulation part 113 is identical with the second security number registered in the memory device 142.

In addition, assuming that memory device 142 has a notification time set therein, the control part 141 is preferably configured to transmit an access time and information about the person who entered/exited to the administrator's wireless communication terminal 190 registered through the communication device 144 and then store the same in the memory device 142 only if a time of inserting the card 160 as read by card reader 117 is identical with the set notification time.

An exemplary controlling procedure by the control part 141 will now be described with reference to FIG. 6.

If a user who intends to enter/exit the door approaches his/her card 160 to the card reader 117 so that the card 160 can be read by the card reader 117, the card reader 117 reads the information recorded in the card 160 to then output to the control part 141.

In step 310, the control part 141 determines whether or not the card 160 read by the card reader 117 is registered in the memory device 142.

If it is determined in step 310 that the card 160 read by the card reader 117 is the same card as that registered in the memory device 142, guide information corresponding to the user is displayed in step 320.

Once the user inputs the password by manipulating key buttons 113a of the key manipulation part 113, it is determined whether the password is identical with a first security number registered in the memory device 142, in step 330.

If the password is not identical with the first security number, an error message is displayed on the display part 115 in step 340.

On the other hand, if the password is identical with the first security number registered in the memory device 142, it is determined whether the current time is equal to the set notification time in step 350.

If it is determined in step 350 that the current time is not equal to the set notification time, the locking rod driver 138 is controlled to be unlocked in step 370.

On the other hand, it is determined in step 350 that the current time is equal to the set notification time, card user information about the user who attempts to enter/exit the door at the current time and access time is transmitted to the administrator's wireless communication terminal 190 with a telephone number registered in the memory device 142 in step 360. Here, the card user information about the person who attempts to enter/exit the door is preferably transmitted in the form of a text message.

Thereafter, the unlocked state is actuated in step 370, and the information about the person who entered/exited is stored in the memory device 142 in step 380.

Meanwhile, in a case where the registered administrator is notified over phone that the person is not allowed to enter the door, the administrator offers the aforementioned second security number to the person, so that the person is allowed to enter/exit the door without a card authentication step. Once the user is allowed to enter/exit based on the second security number, it is desirable for the administrator to renew the second security number.

Further, when the electric door lock device 200 is used in a home, it is preferably not to set a notification time. In such a case, the electric door lock device 200 advantageously allows an administrator, i.e., parent(s), to remotely check an access status of their child through the wireless communication terminal 190.

### INDUSTRIAL APPLICABILITY

As described above, the electric door lock device according to the present invention can notify the administrator's wireless communication terminal of access information of a person who entered/exited. In addition, it is possible to prevent or track down thefts committed by an employee(s) or card user(s) after business hours set in a memory device by installing on an entrance door of an office or company building with accesses of multiple persons.

1. An electric door device comprising:
a user identification (ID) device provided on a manipulation body installed on the outside of a door and configured to input user's unique ID information;
an operation body connected to the manipulation body and including a locking rod driver driving a locking rod for opening/closing the door to be in an unlocked/locked state; and
a controller controlling the locking rod driver to drive the locking rod to a retracted position when user's unique ID information input through the user identification device is identical with user information registered in a memory device, transmitting access information of the user to an administrator's wireless communication terminal registered through a communication device, and storing the access information in the memory device.

2. The electric door lock device of claim 1, wherein the user identification device is a key manipulation part having a plurality of key buttons provided on the manipulation body to input the user's unique ID information, and the manipulation body further includes a display part controlled by the controller and displaying display information.

3. The electric door lock device of claim 1, wherein the user identification device is at least one selected from a card reader, a fingerprint identification device, an iris identification device, and a voice identification device.

4. An electric door lock device comprising:
a user identification (ID) device provided on a manipulation body installed on the outside of a door and configured to identify registered information by user;
a key manipulation part having a plurality of key buttons provided on the manipulation body to input a password;
a display part provided on the manipulation body and displaying display information;
an operation body connected to the manipulation body and provided with a locking rod driver driving a locking rod for opening/closing the door to be in an unlocked/locked state; and
a controller controlling the locking rod driver to drive the locking rod to a retracted position when user's unique ID information identified by the user identification device and the password input through the key manipulation part are identical with the registered information by user and a first security number registered in a memory device, transmitting access information of the user to an administrator's wireless communication terminal registered through a communication device, and storing the access information in the memory device.

5. The electric door lock device of claim 4, wherein when a notification time is set in the memory device and the access time identified by the user identification device is equal to the notification time, the controller stores the access time and information about a person who entered/exited the door in the memory device to then transmit the same to the administrator's wireless communication terminal, and when the access time identified by the user identification device is not equal to the notification time set in the memory device, the controller directly stores the access time and information about the person who entered/exited the door in the memory device without transmitting the same to the administrator's wireless communication terminal.

6. The electric door lock device of claim 4, further comprising a connection port connecting an external terminal to the manipulation body for transmission of information about the person who entered/exited and the access time, which are stored in the memory device, to the external terminal.

7. The electric door lock device of claim 4, wherein the user identification device is a card reader capable of reading information of a card having user's unique ID information recorded therein.

8. The electric door lock device of claim 7, wherein the controller controls the locking rod driver to drive the locking rod to an unlocked position if a second security number is input through the key manipulation part, the second security number set in the memory device to be different from the first security number set, thereby allowing a registered user to enter/exit the door without a user identification step based on the user identification device in a case where the card is lost.
